(19) United States
(12) Patent Application Publication
(10) Pub. No.: US 2022/0112949 A1
(43) Pub. Date: Apr. 14, 2022

(54) Shifter Cart Device

(71) Applicant: Eric Sadler, Westfield, MA (US)

(72) Inventor: Eric Sadler, Westfield, MA (US)

(21) Appl. No.: 17/494,397

(22) Filed: Oct. 5, 2021

Related U.S. Application Data
(60) Provisional application No. 63/089,768, filed on Oct. 9, 2020.

(51) Int. Cl. F16H 61/00; B60R 19/52; B60N 2/24

(52) U.S. Cl. CPC F16H 61/0003; B60Y 2200/114; B60N 2/24; B60R 19/52

(57) ABSTRACT

The present invention relates to an improved go-kart vehicle that has shifter functionality using a dash-mounted shifter control. The go-kart is configured as a rear-wheel drive go-kart for adults, and features a front mounted engine covered by a hood, headlights for illumination, front steering wheel mounted brakes for controlling front wheels, an emergency brake handle for use during drifting and sliding, a dash mounted up-shifter/down-shifter and a removable roll cage. A seat is disposed for a driver to sit with lumbar supports to keep the driver centered. A chain drives a sprocket of a rear axle, and the engine drives the rear axle for driving the go-kart in a smooth manner. The shifter control is used for providing an increased amount of power to the vehicle to generate speed.

### CROSS-REFERENCE TO RELATED APPLICATION

The present application claims priority to, and the benefit of, U.S. Provisional Application No. 63/089,768, which was filed on Oct. 9, 2020 and is incorporated herein by reference in its entirety.

### FIELD OF THE INVENTION

The present invention relates generally to the field of recreational and sporting vehicles. More specifically, the present invention relates to an improved go-kart. The go-kart is configured as a rear-wheel drive go-kart for adults, featuring a front-mounted engine and hood, headlights, front steering wheel-mounted brakes, an emergency brake handle which can be used for drifting, a dash mounted up-shifter/down-shifter and a removable roll cage. A seat is disposed for a driver to sit with lumbar supports to keep the driver centered. A chain drives a sprocket of a rear axle, and the engine drives the rear axle for driving the go-kart in a smooth manner. Accordingly, this disclosure makes specific reference thereto. Nonetheless, it is to be appreciated that aspects of the present invention are also equally applicable to other like applications, devices and methods of manufacture.

### BACKGROUND

Generally, many individuals use go-karts, ATVs and other similar recreational vehicles for leisure and sporting activities. However, these vehicles can become boring and uninspiring after prolonged use. This is especially true when an adult individual wants a go-kart to operate at high speeds without placing high stresses on the drive system of the go-kart. Conventional go-karts can have high rates of wear, a rapid loss of efficiency, a short service life and can create excessive noise.

Further, all-terrain vehicles (ATVs) are also used by individuals for sporting activities. However, when in use the ATVs make excessive noise that is undesirable for users with sensitive ears. Also, the noise generated by the ATV may disturb nearby individuals or animals, which makes it undesirable is an individual is trying to hunt using the ATV. Similarly, other recreational vehicles are not comfortable and are also uninspiring for users. Therefore, said users may look for a more comfortable sporting vehicle that ensures an interesting and fun ride.

Therefore, there exists a long felt need in the art for an improved sporting vehicle that is comfortable to use while performing leisure and sporting activities. There is also a long felt need in the art for an improved sporting vehicle that is not noisy and ensures a quiet ride for users. Finally, there is a long felt need in the art for an improved sporting vehicle that offers fun and entertainment for adult users.

The subject matter disclosed and claimed herein, in one embodiment thereof, comprises a shifter cart device. The device has a front-mounted engine covered with a hood, the hood having a grill and an illumination source, a pair of front wheels connected to each other through a spindle arm, a pair of rear wheels connected to each other through a rear axle, the engine and a chain driving unit for driving the rear wheels by rotating the axle and an emergency brake handle for applying the emergency brakes using the disc brakes during sliding and drifting. The engine is connected to a fuel tank and performs internal combustion of the fuel for driving the rear wheels in addition to the chain driving the sprocket for driving the rear wheels. The engine of the device may be, but is not limited to, a 70 hp four-stroke liquid-cooled motor.

In this manner, the improved shifter cart device of the present invention accomplishes all of the forgoing objectives and provides a multi-purpose, fun and inspiring recreational vehicle. Further, the shifter cart device can be comfortably used by adults. The device further allows users to safely drift or slide and can be used for both on-road and off-road driving.

### SUMMARY OF THE INVENTION

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a shifter cart device. The device is designed to offer fun and entertainment for adult users. The device is further comprised of a front-mounted engine covered with a hood, the hood having a grill and an illumination source, a pair of front wheels connected to each other through a spindle arm, a pair of rear wheels connected to each other through a rear axle, the engine and a chain driving unit for driving the rear wheels by rotating the axle and an emergency brake handle for applying the emergency brakes using the disc brakes. The engine is connected to a fuel tank and performs internal combustion of the fuel for driving the rear wheels in addition to the chain driving the sprocket for driving the rear wheels.

The device is preferably a steering-controlled vehicle, wherein a steering wheel is connected to a steering gear box through a steering shaft and the fuel tank is positioned under the steering wheel. The device further has a seating platform in the form a bucket seat with lumbar supports to keep the driver centered within the seat. The device also includes a rear axle connected to a pair of rear wheels, the axle having at least one sprocket, a front mounted engine driving the rear axle through a driving shaft, and a chain that connects a crankshaft to said sprocket for rotating the sprocket and thus rotating the rear axle, wherein the rear axle is connected to the rear wheels through wheel hubs. The front wheels of the device further have respective spindles that are connected through a spindle arm that allows the steering wheel to steer the front wheels in a desired direction.

The device may also have a shifter control that is used for activating the transmission, to allow the user to shift the gears up or down of the six-speed sequential gears of the device. The shifter control has a low-shifter position and a high-shifter position. When the shifter is activated or set at a high-shifter position, then the device puts power to the ground through a six-speed transmission.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of one potential embodiment of the shifter cart device of the present invention in accordance with the disclosed architecture;

FIG. 2 illustrates a rear top perspective view of one potential embodiment of the shifter cart device of the present invention in accordance with the disclosed architecture;

FIG. 3 illustrates a side perspective view of one potential embodiment of the shifter cart device of the present invention in accordance with the disclosed architecture;

FIG. 4 illustrates a perspective view showing the rear-wheel-drivetrain of one potential embodiment of the shifter cart device of the present invention in accordance with the disclosed architecture;

FIG. 5 illustrates a front perspective view of one potential embodiment of the shifter cart device of the present invention in accordance with the disclosed architecture; and

FIG. 6 illustrates a perspective view of an exemplary disc brake used in one potential embodiment of the shifter cart device of the present invention in accordance with the disclosed architecture.

### DETAILED DESCRIPTION OF THE PRESENT INVENTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there exists a long felt need in the art for an improved sporting vehicle that is comfortable to use while performing leisure and sporting activities. There is also a long felt need in the art for an improved sporting vehicle that is not noisy and ensures a quiet ride for users. Finally, there is a long felt need in the art for an improved sporting vehicle that offers fun and entertainment for adult users.

The present invention, in one exemplary embodiment, is a novel shifter cart device. The device includes a rear axle connecting the pair of rear wheels, the axle having at least one sprocket, a front-mounted engine driving the rear axle through a driving shaft, a chain that connects a crankshaft to the sprocket for rotating the sprocket and thus rotating the rear axle, wherein the rear axle is connected to the rear wheels through wheel hubs.

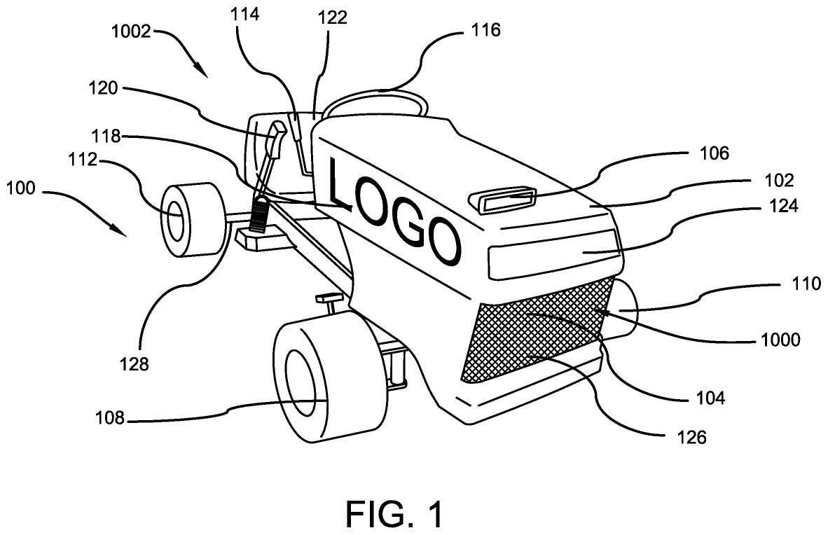

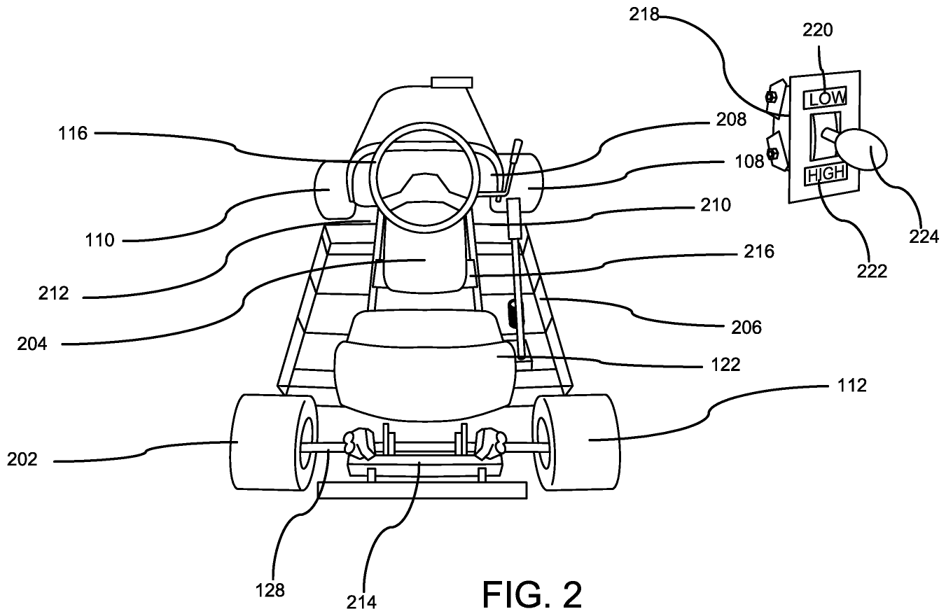

Referring initially to the drawings, FIG. 1 illustrates a perspective view of one embodiment of the shifter cart device 100 of the present invention. The device 100 of the present invention is configured as a rear-wheel drive go-kart for adults that offers fun and entertainment. The device 100 is a simple machine having a small and lightweight frame. Preferably, the device 100 weighs between 150 lbs.-180 lbs. without the driver. The engine 104 of the vehicle 100 propels the rear wheels 112, 202. More specifically, the device 100 comprises a front end 1000 and a rear end 1002. The front end 1000 has a pair of front wheels, a first front wheel 108 and a second front wheel 110 disposed near the front end 1000. Similarly, the rear end 1002 of the device 100 has a pair of rear wheels 112, 202 disposed on the device 100. The first rear wheel 112 and the second rear wheel 202 (shown in FIG. 2) are connected through an axle 128 (as best shown in FIG. 2).

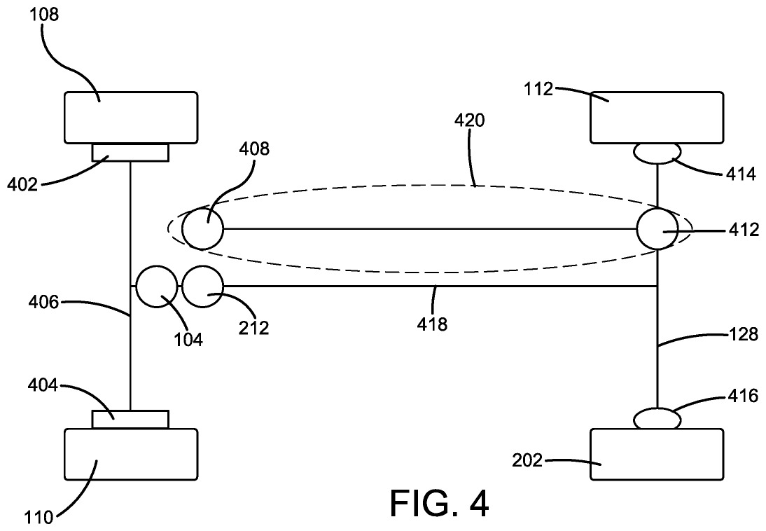

Further, the engine assembly 104 is covered by a hood 102. The hood 102 provides protection of the engine assembly 104 and can be removed to access the engine 104 in case a repair is required. A light bar 106 is preferably positioned in the motor compartment 124 of the hood 102 for providing the necessary illumination in front of the device 100 during use. The light bar 106 can have LED or incandescent light sources that provide illumination in the form of a light beam. The hood 102 can be manufactured of any suitable hard and sturdy metal or lightweight composite material as is known in the art, and is designed for optimum aerodynamics and rigidity to maintain shape integrity. Further, the hood 102 is available in a plurality of colors and can have a logo, indicia, trademark or any personalized design 118. Further, the hood 102 has a grill 126 for allowing the heat developed in the engine 104 to pass into the environment, allowing the device 100 to be used for a longer time period. The engine 104 is preferably a 70 hp, four stroke liquid-cooled motor and the power from the engine 104 is transmitted to the rear axle 128 by a chain 410 (shown in FIG. 4) or other suitable means as is known in the art. Both the engine 104 and the rear axle sprockets 412 are removable. The engine 104 uses internal combustion and uses a fuel and air mixture in order to power the device 100 through the internal combustion.

A seating platform 122 is positioned at the center of the device 100, allowing a driver to access the steering wheel 116 easily while sitting on the seating platform 122. The seating platform 122 is preferably bucket-like in shape, and provides lumbar supports to keep the driver centered within the seating platform 122. The seating platform 122 can be manufactured from plastic, fiberglass or a cushioned material, etc., or any other suitable material as is known in the art. The seat 122 can also have a curved torso region that supports the lower seating position and body angle of a user. The steering wheel 116 is further used for making a desired movement and turning of the front wheels 108, 110. The steering wheel 116 has an associated lever 114 mounted on the steering wheel 116 for easy and quick access.

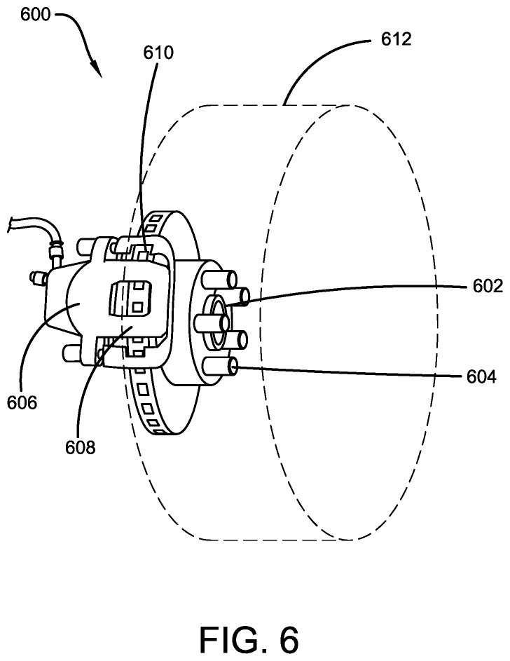

Further, an emergency brake handle 120 is connected to the disc brakes 600 (shown in FIG. 6) which is mounted on both the rear wheels 112, 202 and the front wheels 108, 110. It should be noted that in one embodiment, disc brakes 600 may be mounted only on the front wheels 108, 110. The emergency brake can further be activated by the handle 120 to lock the brakes 600, to allow the device 100 to drift or slide. The wheels 108, 110, 112, 202 of the device 100 are much smaller than those used on a normal vehicle, and the rims of the wheels 108, 110, 112, 202 can be manufactured of a magnesium alloy, aluminum, composite material, etc., or any other suitable material as is known in the art. In differing embodiments, the wheels 108, 110, 112, 202 can have different types and sizes of tires, such as slick kart tires, wet tires or spiked tires, etc., or any other suitable type of tire as is known in the art.

FIG. 2 illustrates a rear top perspective view of one embodiment of the shifter cart device 100 of the present invention. The rear axle 128 is supported by the base (frame) 214 of the device 100 and the base 214 extends from the rear to the front part of the device 100 providing support to the seat 122 and other components. The gas tank 204 is preferably positioned at the center of the base 214 on the gas tank platform 216, with a gas pedal 210 positioned on the right side in front of the gas tank 204 and a clutch pedal 212 positioned on the left side in front of the gas tank 204. The gas tank 204 holds the fuel for the engine 104 and is positioned just below the steering wheel 116 to save space for the seat 122 and the legs of the driver sitting on the seat 122. The gas tank 204 comes in different shapes and sizes, and can be manufactured from different materials, but is preferably made of high-density polyethylene (HDPE), and alternatively can be of either stainless steel or aluminum, etc., or any other suitable material as is known in the art.

It should be noted that the pedal 210, 212 placement is similar to that of a traditional vehicle, such that a user can use the device 100 in a conventional manner. The clutch pedal 212 is specifically made to exhibit centrifugal force, thus, manual shifting of the gears is not required by the driver of the vehicle. The clutch pedal 212 is directly attached to the crankshaft 408. Once the engine 104 reaches a certain speed, the clutch pedal 212 causes the engine 104 to transfer power to the rear axle 128 via two sprockets 412 and a chain 410 (shown best in FIG. 4).

Additionally, the dashboard 208 of the device 100 comprises a dash mounted up-shifter/down-shifter control 218 that can be used to manually shift the device 100 in one embodiment. The shifter control 218 is used for activating the transmission, allowing the driver to upshift or downshift the gears of the device 100. The shifter control 218 preferably has a low-shifter position 220 and a high-shifter position 222, and the shifter control 218 can be set to any one of the two positions using the control knob 224. The shifter control 218 is mounted to the dashboard 208 and is easily accessible to the driver. In addition to the base frame 214, the device 100 has a cage-like structure 206 for providing further support to the device 100. The cage-like structure 206 can be manufactured from any suitable hard and lightweight metal as is known in the art.

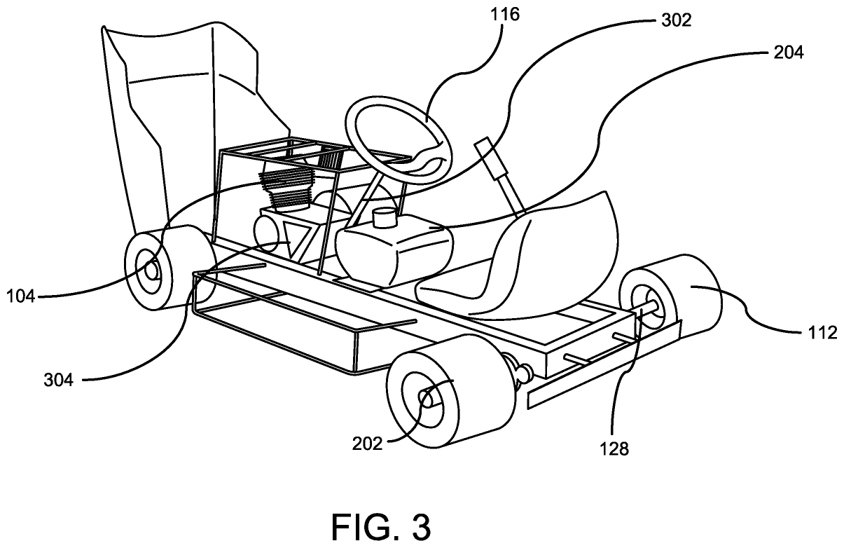

FIG. 3 illustrates a side perspective view of one embodiment of the shifter cart device 100 of the present invention. The present embodiment of the device 100 shows that the steering wheel 116 comprises a steering shaft 302 through which the steering wheel 116 is connected to a steering gearbox 304. The steering gearbox 304 contains the gears that transmit the driver's steering inputs for turning the front wheels 108, 110. The rear axle also 128 provides rotational motion to the rear wheels 112, 202 from the torque that is generated via the engine 104.

FIG. 4 illustrates a perspective view showing the rear-wheel-drivetrain of one embodiment of the shifter cart device 100 of the present invention. It should be noted that in addition to the clutch 212, the device 100 also uses at least one chain 410 and sprockets 412 for providing rotation to the rear wheels 112, 202. In conjunction with the clutch pedal 212, the chain 410 and sprockets 412 transfer the power from the engine 104 to the rear axle 128. The front wheels 108, 110 are not connected through an axle but are connected to each other through a spindle arm 406. The first front wheel 108 has an associated first spindle 402 and the second front wheel 110 has an associated second spindle 404, wherein the first spindle 402 and the second spindle 404 are connected through the spindle arm 406. As stated earlier, the device 100 is configured as a rear-wheel drive go-kart for adults and thus, both the engine 104 and the drive train 420 drive the rear-wheel axle 128.

Further, the transmission is provided preferably through the driving shaft 418. The internal combustion of the fuel in the engine 104 provides the necessary power to the rear axle 128. For additional power for driving the rear axle 128, the chain driving unit 420 is used, that has a chain 410 connecting the crankshaft 408 to the sprocket 412. The chain 410 connects two sprockets 412 (one attached to the crankshaft 408 and the other to the rear axle 128), in order to facilitate rotational power transfer from one sprocket to another. The sprocket 412 is a toothed-wheel and functions to rotate the rear axle 128 via the chain 410. It should be noted that both the chain 410 and the sprockets 412 are compatible with one another. Further, a first wheel hub 414 is connected to the first rear wheel 112 and the second wheel hub 416 is connected to the second rear wheel 202. The hubs 414, 416 allow the rear axle 128 to connect to and rotate the rear wheels 112, 202. It should be noted that the spindles 402, 404 of the front wheels 108, 110 can be connected to hubs as well, which may be the same or different from the hubs 414, 416 of the rear wheels 112, 202, as the front wheels 108, 110 have spindles 402, 404 and not an axle 128.

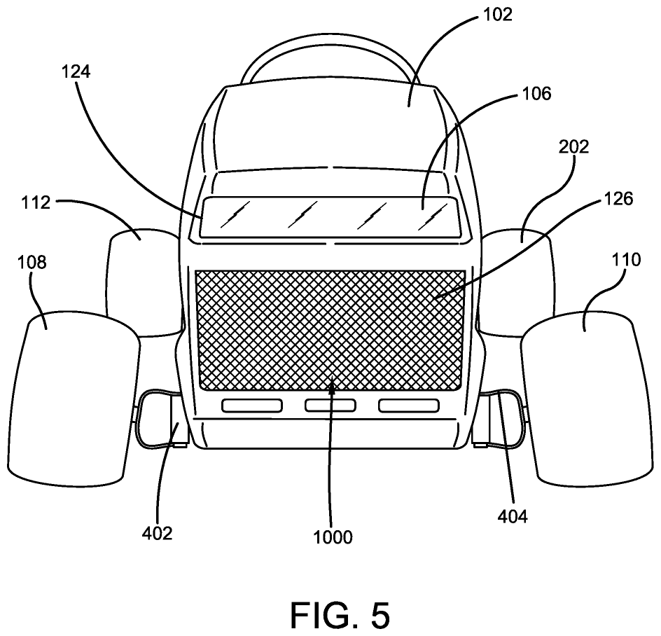

FIG. 5 illustrates a front perspective view of one embodiment of the shifter cart device 100 of the present invention. At the front end 1000, the hood 102 has a grill 126 for exhausting compressed air and the motor component 124 has an illumination source 106 in the form of a LED source that can be powered by the engine after conversion to DC power. Also, the first spindle 402 is connected to the first front wheel 108 and the second spindle 404 is connected to the second front wheel 110. Further, the rear axle also 128 provides rotational motion to the rear wheels 112, 202 from the torque that is generated via the engine 104.

FIG. 6 illustrates a perspective view of an exemplary disc brake 600 used in the shifter cart device 100 of the present invention. The exemplary disc brake 600 can be used with rear wheels 112, 202 and also with front wheels 108, 110 as required by the user. The brake 600 is connected to the wheel hub 602 and has wheel studs 604 which allows the brake 600 to be attached to a wheel 108, 110, 112, 202. More specifically, the disc brake 600 has a brake caliper 606 that has a caliper bracket 608 from which the brake pads 610 are attached to the working surface of the disc 612, which provides a braking effect to the wheels 108, 110, 112, 202 to which the brake 600 is attached.

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “improved go-kart”, “shifter cart”, “go-kart vehicle”, “shifter cart device”, and “vehicle” are interchangeable and refer to the improved go-kart 100 of the present invention.

Notwithstanding the forgoing, the improved go-kart 100 of the present invention can be of any suitable size and configuration as is known in the art without affecting the overall concept of the invention, provided that it accomplishes the above-stated objectives. One of ordinary skill in the art will appreciate that the size, configuration and material of the improved go-kart 100 as shown in FIGS. 1-6 is for illustrative purposes only, and that many other sizes and shapes of the improved go-kart 100 are well within the scope of the present disclosure. Although the dimensions of the improved go-kart 100 are important design parameters for user convenience, the improved go-kart 100 may be of any size that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A shifter cart device that is configured as a rear-wheel drive go-kart for adults for performing leisure and sporting activities, the shifter cart device comprising:
a hood comprising a grill for heat dissipation;
a frame;
a front end comprising a set of front wheels;
a rear end comprising a set of rear wheels;
an engine that propels the set of rear wheels and is covered by the hood for protection;
a steering wheel for turning the set of front wheels;
a seat for allowing a user to access the steering wheel while sitting on the seat;
a rear axle connecting the set of rear wheels;
a shifter allows a user to upshift or downshift; and
at least one disc brake.

2. The shifter cart device of claim 1 further comprising a light bar positioned on the hood for providing necessary illumination in front of the shifter cart device during use.

3. The shifter cart device of claim 2, wherein the light bar comprises LED lights.

4. The shifter cart device of claim 1, wherein the engine uses internal combustion and uses a fuel and air mixture in order to power the shifter cart device.

5. The shifter cart device of claim 1, wherein the seat is bucket-like in shape and provides lumbar supports to keep the user centered within the seat.

6. The shifter cart device of claim 1, wherein the at least one disc brake is mounted on both the set of rear wheels and the set of front wheels.

7. A shifter cart device that can drift or slide and that is configured as a rear-wheel drive go-kart for adults for performing leisure and sporting activities, the shifter cart device comprising:
a hood comprising a grill for heat dissipation and a light bar;
a frame;
a gas tank;
a front end comprising a set of front wheels;
a rear end comprising a set of rear wheels;
an internal combustion engine that propels the set of rear wheels and is covered by the hood for protection;
a steering wheel for turning the set of front wheels;
a bucket-like seat for allowing a user to access the steering wheel while sitting on the bucket-like seat;
an emergency brake;
a rear axle connecting the set of rear wheels;
a gas pedal and a clutch pedal;
a crankshaft;
a shifter allows a user to upshift or downshift; and
at least one disc brake further comprised of a wheel hub, a plurality of wheel studs, a brake caliper, a disc, and a brake pad.

8. The shifter cart device of claim 7, wherein the at least one disc brake is mounted on both the set of rear wheels and the set of front wheels.

9. The shifter cart device of claim 7, wherein the emergency brake allows the brake caliper to lock to allow the shifter cart device to drift or slide.

10. The shifter cart device of claim 7, wherein the set of front wheels are connected by a spindle arm.

11. A shifter cart device that can drift or slide and that is configured as a rear-wheel drive go-kart for adults for performing leisure and sporting activities, the shifter cart device comprising:
a hood comprising a grill for heat dissipation and a light bar;
a frame;
a gas tank;
a front end comprising a set of front wheels;
a rear end comprising a set of rear wheels;
an internal combustion engine that propels the set of rear wheels and is covered by the hood for protection;
a steering wheel comprising a steering gearbox for turning the set of front wheels;
a bucket-like seat for allowing a user to access the steering wheel while sitting on the bucket-like seat;
an emergency brake;
a rear axle connecting the set of rear wheels and having at least one sprocket;
wherein the internal combustion engine drives the rear axle through a driving shaft, and a chain that connects a crankshaft to the at least one sprocket for rotating the at least one sprocket and thus rotating the rear axle, and wherein the rear axle is connected to the rear wheels through wheel hubs;
a gas pedal and a clutch pedal;
a shifter allows a user to upshift or downshift; and
at least one disc brake further comprised of a wheel hub, a plurality of wheel studs, a brake caliper, a disc, and a brake pad.

12. The shifter cart device of claim 11, wherein the emergency brake allows the brake caliper to lock to allow the shifter cart device to drift or slide.

13. The shifter cart device of claim 11, wherein the gas tank is positioned below the steering wheel.

14. The shifter cart device of claim 11, wherein the shifter cart device is further comprised of an at least one chain and a plurality of sprockets that provide rotation to the set of rear wheels.

15. The shifter cart device of claim 11, wherein the set of front wheels are connected by a spindle arm.

16. The shifter cart device of claim 14, wherein the shifter cart device is further comprised of a chain driving unit that houses the at least one chain which connects to the plurality of sprockets.

17. The shifter cart device of claim 11, wherein the shifter has a high-position and a low-position.

18. The shifter cart device of claim 17, wherein the shifter is located on a dashboard of the shifter cart device.

19. The shifter cart device of claim 11, wherein the light bar comprises LED lights.

20. The shifter cart device of claim 11, wherein the bucket-like seat provides lumbar support to a user to keep the user centered within the bucket-like seat.
